(19) United States
(12) Patent Application Publication
(10) Pub. No.: US 2026/0126553 A1
(43) Pub. Date: May 7, 2026

(54) METHOD FOR MONITORING THE INTEGRITY OF A PLURALITY OF PSEUDORANGE MEASUREMENTS ACQUIRED BY A NAVIGATION SYSTEM

(71) Applicant: SAFRAN ELECTRONICS & DEFENSE, Paris (FR)

(72) Inventor: Yves Becheret, Moissy-Cramayel (FR)

(73) Assignee: SAFRAN ELECTRONICS & DEFENSE, Paris (FR)

(21) Appl. No.: 19/117,350

(22) PCT Filed: Oct. 2, 2023
(86) PCT No.: PCT/FR2023/051524

§ 371 Date: Mar. 31, 2025

(30) Foreign Application Priority Data
Oct. 3, 2022 (FR) 2210101

(51) Int. Cl. G01S 19/20; G01S 19/39

(52) U.S. Cl. CPC G01S 19/20; G01S 19/393

(57) ABSTRACT

This method for monitoring the integrity of a plurality of pseudorange measurements acquired by a navigation system from signals transmitted by a constellation of satellites includes:
a first calculation, for each satellite of the constellation, of a first innovation (Inno) reflecting the deviation between the measured pseudorange from said satellite and a value of said pseudorange estimated after the event, produced by a Kalman filter;
a first update of each first innovation (Inno);
a second calculation of a first group of first test values (CM);
maintaining the set of measured pseudoranges so as to calibrate the Kalman filter if all of the first test values (CM) are less than a first predetermined threshold, otherwise implementing a processing step.

### TECHNICAL FIELD

The present invention relates to satellite navigation systems and pertains more particularly to the detection and exclusion of faulty satellites.

### PRIOR ART

The guidance systems currently used in automotive, avionics or even maritime navigation are generally hybrid INS/GNSS (‘Inertial Navigation System’ and ‘Global Navigation Satellite System’) equipment.

This hybrid equipment simultaneously uses two measurement sources of physical variables intended to be used so as to provide the location data necessary for the navigation of the vehicle.

A first measurement source may be an inertial system of which the physical variables are acquired by inertial sensors such as accelerometers or gyroscopes.

Such measurements are subsequently exploited so as to provide accurate location, speed and orientation data in the short term which, nevertheless, tend to drift in the long term.

To circumvent this problem, a second measurement source may be a constellation of satellites that thus deliver accurate data in the long term but of which the processing retains noise and therefore makes the operation thereof difficult.

These satellite data are known as ‘pseudoranges’ and make it possible to obtain the associated positions and dates of the receiving antenna of the vehicle.

To combine the data from said measurement sources, guidance (or navigation) systems generally include a bank of Kalman filters.

More precisely, the bank of Kalman filters includes a main filter intended to use the set of pseudoranges, and a series of secondary filters using only part of the available pseudoranges.

Nevertheless, when one of the satellites of said constellation is faulty, the satellite signal that it transmits may lead to pseudorange measurement errors.

To protect against a possible satellite failure and the consequences thereof, the Kalman filter is configured to determine a reset value so as to reduce the influence of errors associated with degraded satellite signals.

The reset value is then generated by comparing a measurement external to the filter, known as an observation, with a measurement processed by said filter.

The deviation between the two measurements is known as ‘innovation’ and thus serves as a reset value.

There are a plurality of algorithms intended to process a set of observations. By way of example, the object of the so-called ‘separation’ algorithm is to perform, for each reset cycle, intermediate innovation tests. Each observation is then dependent on the previous observations.

However, such an algorithm may lead to more or less significant consequences depending on the order for processing the erroneous pseudorange.

Thus, if the measurement of the erroneous pseudorange is processed in the last position by this algorithm, the reset value will be consistent.

Nevertheless, when said measurement is processed first by the algorithm, the error propagates through the successive intermediate innovation tests.

The variance of the innovations is then higher and the erroneous pseudoranges become difficult to detect.

A first solution consists in modifying the program instructions of this algorithm to compare each pseudorange measurement acquired by the navigation system with the same measurement processed by the filter and which is associated with the observation processed first.

Nevertheless, the standard deviation of innovations is higher. The reset values are then dispersed and random.

There is therefore a need to improve the detection and exclusion of faulty satellites before navigation begins.

### DISCLOSURE OF THE INVENTION

In view of the foregoing, the object of the invention is a method for monitoring the integrity of a plurality of pseudorange measurements acquired by a navigation system from signals transmitted by a constellation of satellites, comprising:
a first calculation, for each satellite of the constellation, of a first innovation reflecting the deviation between the measured pseudorange from said satellite and a value of said pseudorange estimated after the event, produced by a filter;
a first update of each first innovation depending on the mean of all of the first innovations so as to constitute a second innovation with which a variance is associated, the variance being equal to the mathematical expectation of the squares of the deviations from the mean of the second innovations;
a second calculation of a first group of first test values depending on all of the second innovations and the variances thereof,
maintaining the set of measured pseudoranges so as to calibrate the filter from the set of pseudoranges if all of the first test values are less than a first predetermined threshold, otherwise implementing a processing step that comprises the following sub-steps:
   removing the set of pseudoranges of the pseudorange of which the second innovation is associated with the first highest test value as well as removing the first innovation associated with it from all of the first innovations;
   a second update of each first innovation depending on the mean of all of the first remaining innovations so as to constitute a third innovation with which a variance is associated, the variance being equal to the mathematical expectation of the squares of the deviations from the mean of the third innovations;
   calculating a second group of second test values depending on the third innovations and the variances thereof, and,
   maintaining the remaining pseudoranges so as to calibrate the filter if all of the second test values are less than said first predetermined threshold, otherwise transmitting an alarm signal to the navigation system.

As the clock of the receiver of the navigation system is likely to be erroneous and thus propagate a time error over a few seconds between two resets, it is advantageous to first eliminate it before producing a reset value.

To this end, using the mean of the first innovations to update the value of each first innovation makes it possible to reduce the variance.

Subsequently, to identify the erroneous pseudorange measurement from the set of pseudoranges making it possible to obtain a filter reset value, it is proposed to perform a series of comparisons with the first predetermined threshold selected according to the desired false alarm rate.

The first threshold is for example between 3 and 5 for a probability that an alarm is triggered when no satellite is faulty between 10⁻³ to 10⁻⁶ assuming a Gaussian distribution of the errors without failure. Intermediate innovation tests are then eliminated.

Advantageously, a notification is transmitted to the navigation system so as to configure the filter according to nominal ionospheric conditions when all of the first test values are less than a second predetermined threshold.

Ionospheric conditions are nominal when layers of the high atmosphere comprise ions that have sufficient density to reflect electromagnetic waves. Alternatively, the alarm signal is transmitted to the navigation system so as to configure the filter according to degraded ionospheric conditions when all of the first test values are greater than a predetermined third threshold.

According to another alternative embodiment, the satellite of which the pseudorange has been removed is excluded for an adjustable time.

Preferably, the filter is a main filter.

The number of calculations performed is then reduced because the method does not require the use of secondary filters.

Another object of the invention is a device for monitoring the integrity of a plurality of pseudorange measurements acquired by a navigation system from signals transmitted by a constellation of satellites, the device comprising:
calculation means capable, for each satellite of the constellation, of calculating a first innovation reflecting the deviation between the measured pseudorange from said satellite and a value of said pseudorange estimated after the event, produced by a filter.

More particularly, the device comprises:
means for updating each first innovation depending on the mean of all of the first innovations so as to constitute a second innovation with which a variance is associated, the variance being equal to the mathematical expectation of the squares of the deviations from the mean of the second innovations;
a calculation unit capable of calculating a first group of first test values depending on all of the second innovations and the variances thereof,
processing means capable of maintaining the set of measured pseudoranges so as to calibrate the filter if all of the first test values are less than a predetermined first threshold, otherwise capable of performing:
   removing the pseudorange of which the second innovation is associated with the first highest test value as well as removing the first innovation that is associated with it;
   a second update of each first innovation depending on the mean of all of the first remaining innovations so as to constitute a third innovation with which a variance is associated, the variance being equal to the mathematical expectation of the squares of the deviations from the mean of the third innovations;
   calculating a second group of second test values depending on the third innovations and the variances thereof, and,
   maintaining the remaining pseudoranges so as to calibrate the filter if all of the second test values are less than said first predetermined threshold, otherwise transmitting an alarm signal to the navigation system.

Advantageously, the device comprises transmission means intended to send a notification to the navigation system so as to configure the filter according to nominal ionospheric conditions when all of the first test values are less than a second predetermined threshold.

Alternatively, the processing means are capable of transmitting the alarm signal to the navigation system so as to configure the filter according to degraded ionospheric conditions.

According to another alternative embodiment, the processing means are capable of excluding for an adjustable time the satellite of which the pseudorange has been removed.

Yet another object of the invention is a navigation system comprising a receiver capable of acquiring pseudorange measurements from signals transmitted by a constellation of satellites, and a device for monitoring the integrity of said measurements as defined above.

### BRIEF DESCRIPTION OF THE DRAWINGS

Other aims, features and advantages of the invention will become apparent upon reading the following description, given only by way of a non-limiting example, and made with reference to the appended drawings, wherein:

FIG. 1 shows a navigation system communicating with a constellation of satellites according to the invention;

FIG. 2 illustrates a device for monitoring the integrity of a plurality of pseudorange measurements acquired by said navigation system according to one embodiment of the invention and,

FIG. 3 presents a flowchart of a method for monitoring the integrity of said pseudorange measurements according to one implementation of the invention.

### DETAILED DISCLOSURE OF AT LEAST ONE EMBODIMENT OF THE INVENTION

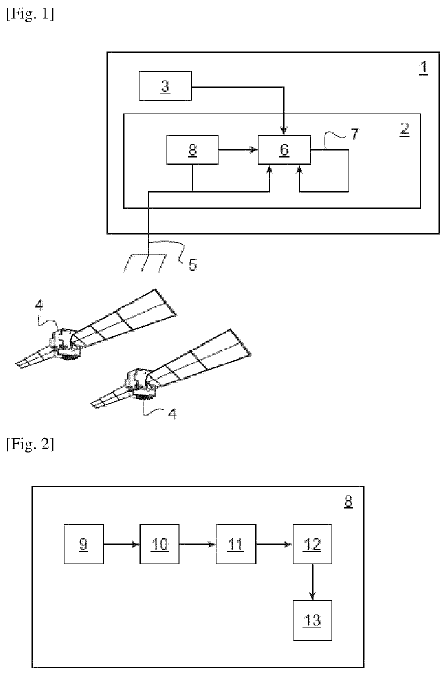

FIG. 1 shows a vehicle 1 carrying onboard a hybrid navigation system 2 intended to use inertial measurements coming from an inertial system 3 and, on the other hand, pseudorange measurements determined from the reception of signals from a constellation of INS/GNSS satellites 4.

More precisely, the inertial system 3 is intended to measure physical variables from inertial sensors such as accelerometers or gyroscopes, so as to deliver location, speed and orientation data of the vehicle 1.

As for the satellites 4, they are configured to deliver the position and/or speed of the vehicle 1.

By way of example, such a constellation may be GALILEO or BEIDOU or any other array of satellites capable of transmitting positioning signals that make it possible for the navigation system 2 to measure pseudoranges.

Moreover, ‘pseudoranges’ means an indirect measurement of ranges by a measurement of the time of reception of a signal dated at transmission, when the clocks of a transmitter, here each satellite 4 and of a receiver, are not synchronised.

To this end, the navigation system 2 comprises a receiver 5 capable of acquiring said positioning satellite signals.

Such a receiver 5 comprises at least one processor intended to determine pseudoranges from the received signals.

To combine the data from the satellites 4 and those from the inertial system 3, the navigation system 2 comprises a bank of Kalman filters 6 intended to deliver a navigation solution to the vehicle 1.

The bank of Kalman filters 6 includes a main filter intended to use the set of pseudoranges, and a series of secondary filters using only part of the available pseudoranges. ‘Kalman filter 6’ will only designate the main filter.

Nevertheless, when a satellite 4 of said constellation is faulty, the positioning signal is altered and therefore provides an erroneous pseudo-measurement leading to the delivery of a false pseudorange.

The Kalman filter 6 then conventionally determines the reset value 7 thereof to reduce the impact of errors from said faulty satellite.

More precisely, the reset value 7, also known as ‘innovation’, is produced by comparing an observation and a measurement processed by the Kalman filter 6.

Nevertheless, it is necessary to effectively detect erroneous pseudoranges that are likely to have an impact on the navigation of the vehicle 1.

For this purpose, the navigation system 2 comprises a device 8 coupled to the Kalman filter 6 and to the receiver 5 so as to monitor the integrity of the pseudorange measurements intended to supply said Kalman filter 6.

In other words, the device 8 is capable of detecting and excluding a possible faulty satellite 4 and this before the navigation of the vehicle 1 begins.

Such a device 8 comprises, as illustrated in FIG. 2, calculation means 9 capable, for each satellite 4, of calculating a first innovation reflecting the deviation between the measured pseudorange and a value of said pseudorange estimated after the event, produced by the Kalman filter 6.

Of course, the invention is not limited to a particular type of filter, namely the Kalman filter 6 described previously. The invention relates to any filter capable of estimating said pseudorange produced after the event.

Thus, any reference to the Kalman 6 filter in the description also applies to any type of filter capable of performing the same functions as the Kalman filter within the scope of the invention.

The device 8 further comprises updating means 10 coupled to the calculation means 9 and intended to update each first innovation depending on the mean of said first innovations.

The update means 10 are then configured to deliver, from the update of each first innovation, a group of second innovations and the respective variances thereof to a calculation unit 11 of the device 8.

More precisely, the calculation unit 11 is configured to calculate a first group of test values depending on all of the second innovations and the respective variances thereof and thus obtain a first group of first test values.

The device 8 further comprises processing means 12 coupled to the calculation unit 11 and configured to maintain the set of measured pseudoranges so as to deliver the reset value 7 and to identify a possible erroneous pseudorange in order to exclude it.

In this latter case, the processing means 12 are configured to make it possible for the Kalman filter 6 to produce the reset value 7 depending on the remaining pseudoranges.

The device 8 also comprises transmission means 13 capable of sending a notification to the navigation system 2 to configure the Kalman filter 6 according to nominal ionospheric conditions.

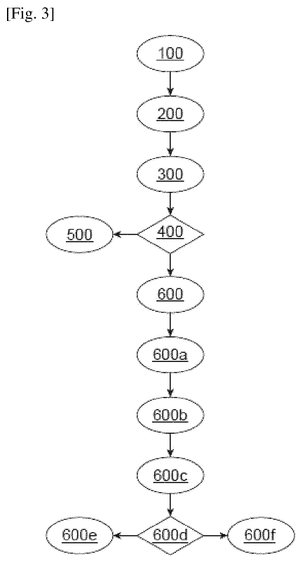

Reference is now made to FIG. 3 that illustrates a flowchart of a method implemented by the device 8 and the object of which is to monitor the integrity of the measurements of said pseudoranges.

The method begins with a step 100, during which the calculation means 9 determine, for each satellite 4 of the constellation, a first innovation reflecting the deviation between the measured pseudorange from said satellite 4 and the value estimated after the event, produced by the Kalman filter 6.

In step 200, the updating means 10 modify the value of each first innovation depending on the mean of all of the first innovations to obtain a set of second innovations.

More particularly, it will be considered that there are N first innovations Inno, for example 5.

The update means 10 then perform the following calculation N times:

$$IM ( i ) = Inn o ( i ) - mean ( Inno ( i ) , i = 1 , … , N ) \qquad ( 1 )$$

where i represents the order of a first defined innovation and, IM(i) a second innovation with which a variation Vm(i) is associated.

The variance VM is the mathematical expectation of the squares of the deviations from the mean of the second innovations IM (square of the standard deviation).

Thus, by determining the second innovations, the variance is reduced, which makes it possible to detect more easily any erroneous pseudoranges.

In step 300, the calculation unit 10 determines a first group of test values CM depending on all of the second innovations IM and the variances VM thereof.

In other words, the calculation unit 10 performs the following calculation for each second innovation IM:

$$CM ( i ) = ( \frac{( IM ( i ) ) \hat{} 2}{V M ( i )} ) \qquad ( 2 )$$

where i represents the order of each first test value CM.

In step 400, the processing means 12 perform a comparison represented by the following equation for each first test value CM:

$$CM ( i ) < {k}^{2} \qquad ( 3 )$$

where k is a first threshold selected according to the desired false alarm rate.

Subsequently, if all of the first test values CM are less than the first threshold k², the processing means 12 maintain, during step 500, the set of measured pseudoranges so as to calibrate the Kalman filter 6.

Moreover, if each first test value CM is less than a second predetermined threshold which is itself less than the first threshold k², the transmission means 13 may transmit to the navigation system 2 a notification so as to configure the Kalman filter 6 according to nominal ionospheric conditions.

Nevertheless, in step 600, if one of the first test values CM is greater than or equal to the first threshold k², the processing means 12 remove in step 600a the pseudorange of which the second innovation IM(i) is associated with the highest first test value CM(i).

The processing means 12 also remove the first associated innovation Inno(i) from the set of first innovations Inno intended to calibrate the Kalman filter 6.

Following this step, the processing means 12 implement a series of processing steps relating to the first remaining innovations.

More precisely, in step 600b, the processing means 12 update each first innovation Inno(i) depending on the mean of all of the first remaining innovations Inno.

In other words, the processing means 12 perform the following calculation for each first innovation Inno(i), i representing N−1 first innovations:

$$IR ( i ) = Inno ( i ) - mean ( Inno ( i ) , i = 1 , … , N - 1 ) \qquad ( 4 )$$

where i represents the order of a first defined innovation and, IR(i) a third innovation with which a variation VR(i) is associated

The variance VR is the mathematical expectation of the squares of the deviations from the mean of the third innovations IR (square of the standard deviation).

The processing means 12 subsequently calculate in step 600c, according to the following formula, a second group of second test values CR depending on said third innovations IR and the respective variances VR thereof:

$$C R ( i ) = ( \frac{( IR ( i ) ) \hat{} 2}{V R ( i )} ) \qquad ( 5 )$$

where i represents the order of each first test value CR.

The processing means 12 thus compare each second test value CR with the first threshold k² in step 600d The processing means 12 maintain, in step 600e, the remaining pseudoranges so as to calibrate the Kalman filter 6 if all of the second CR test values are less than k².

Otherwise, in step 600f, the processing means 12 transmit an alarm signal to the navigation system 2 if at least one second test value (CR) is greater than said first predetermined threshold.

The alarm signal makes it possible for example for the navigation system 2 to configure the Kalman filter 6 according to degraded ionospheric conditions.

Alternatively, the alarm signal makes it possible for the navigation system 2 to exclude for an adjustable time the satellite 4 of which the pseudorange has been removed.

Of course, the invention is not limited to the embodiments and implementations described above and provided only by way of example.

In particular, it is possible to replace the Kalman filter 6 with a least squares filter, invariant or fragrance-free.

1. A method for monitoring the integrity of a plurality of pseudorange measurements acquired by a navigation system from signals transmitted by a constellation of satellites, comprising the following steps:
a step of a first calculation, for each satellite of the constellation, of a first innovation (Inno) reflecting the deviation between the measured pseudorange from said satellite and a value of said pseudorange estimated after the event, produced by a filter;
a step of a first update of each first innovation depending on the mean of all of the first innovations so as to constitute a second innovation with which a variance is associated, the variance being equal to the mathematical expectation of the squares of the deviations from the mean of the second innovations;
a step of a second calculation of a first group of first test values depending on all of the second innovations (Inno) and the variances thereof;
a step of comparing all of the first test values with a first predetermined threshold;
a step of maintaining the set of measured pseudoranges so as to calibrate the filter from the set of pseudoranges if all of the first test values are less than a first predetermined threshold; and
a step of implementing a processing step if one of the first test values is greater than said first threshold, the implementation step comprising the following steps:
a step of removing the set of pseudoranges of the pseudorange of which the second innovation is associated with the first highest test value as well as the first innovation that is associated with it from all of the first innovations;
a step of a second update of each first innovation (Inno) depending on the mean of all of the first remaining innovations so as to constitute a third innovation with which a variance is associated, the variance being equal to the mathematical expectation of the squares of the deviations from the mean of the third innovations;
a step of calculating a second group of second test values depending on the third innovations and the respective variances thereof;
a step of comparing the second test values with said first predetermined threshold;
a step of maintaining the remaining pseudoranges so as to calibrate the filter if all of the second test values are less than said first predetermined threshold; and
a step of transmitting an alarm signal to the navigation system if at least one second test value is greater than said first predetermined threshold.

2. Method according to claim 1, wherein a notification is transmitted to the navigation system so as to configure the filter according to nominal ionospheric conditions when all of the first test values are less than a second predetermined threshold.

3. Method according to claim 1, wherein the alarm signal is transmitted to the navigation system so as to configure the filter according to degraded ionospheric conditions.

4. Method according to claim 1, wherein the satellite of which the pseudorange has been removed is excluded for an adjustable time.

5. Method according to claim 1, wherein the filter is a main filter.

6. Device for monitoring the integrity of a plurality of pseudorange measurements acquired by a navigation system from signals transmitted by a constellation of satellites, the device comprising:
calculation means capable, for each satellite of the constellation, of calculating a first innovation reflecting the deviation between the measured pseudorange from said satellite and a value of said pseudorange estimated after the event, produced by a filter, wherein the device comprises:
means for updating each first innovation depending on the mean of all of the first innovations so as to constitute a second innovation with which a variance is associated, the variance being equal to the mathematical expectation of the squares of the deviations with the mean of the second innovations;
a calculation unit capable of calculating a first group of first test values depending on all of the second innovations and the variances thereof; and
processing means capable of comparing all of the first test values with a first predetermined threshold and of maintaining the set of measured pseudoranges so as to calibrate the filter if all of the first test values are less than a first predetermined threshold, the processing means being capable, if one of the first test values is greater than said first threshold, of performing:
removing the pseudorange of which the second innovation is associated with the first highest test value as well as the first innovation associated with it;
a second update of each first innovation depending on the mean of all of the first innovations so as to constitute a third innovation with which a variance is associated, the variance being equal to the mathematical expectation of the squares of the deviations from the mean of the third innovations;
calculating a second group of second test values depending on the third innovations and the respective variances thereof;
comparing the second test values with said first predetermined threshold;
maintaining the remaining pseudoranges so as to calibrate the filter if all of the second test values are less than said first predetermined threshold; and
transmitting an alarm signal to the navigation system if at least one second test value is greater than said first predetermined threshold.

7. Device according to claim 6, comprising transmission means intended to send a notification to the navigation system so as to configure the filter according to nominal ionospheric conditions when all of the first test values are less than a second predetermined threshold.

8. Device according to claim 6, wherein the processing means are capable of transmitting the alarm signal to the navigation system so as to configure the filter according to degraded ionospheric conditions.

9. Device according to claim 6, wherein the processing means are capable of excluding for an adjustable time the satellite of which the pseudorange has been removed.

10. A navigation system comprising a receiver capable of acquiring pseudorange measurements from signals transmitted by a constellation of satellites, and a device for monitoring the integrity of said measurements according to claim 6.
